(19) United States
(12) Patent Application Publication
(10) Pub. No.: US 2026/0212672 A1
(43) Pub. Date: Jul. 23, 2026

(54) Method, Computer Program, Carrier and Server for Extending a Memory

(71) Applicant: Telefonaktiebolaget LM Ericsson (publ), Stockholm (SE)

(72) Inventors: Niklas Lindskog, Lund (SE); Gunilla Berndtsson, Nacka (SE); Peter Ökvist, Luleå (SE); Tommy Arngren, Södra Sunderbyn (SE)

(21) Appl. No.: 19/113,992

(22) PCT Filed: Oct. 13, 2022
(86) PCT No.: PCT/EP2022/078569

§ 371 Date: Mar. 21, 2025

(51) Int. Cl. G06V 20/40; G06Q 10/40; H04L 67/52

(52) U.S. Cl. CPC G06V 20/44; G06Q 10/40; G06V 20/42; H04L 67/52

(57) ABSTRACT

A method performed by a server is provided. The method is for handling an expanded memory associated with a user device in a communications network. The server obtains (201) a request related to the user device. The request is requesting to extend a memory according to a location area and a time frame. The server receives (203) additional data requested by the server. The additional data is related to the location area and the time frame and is received from one or more respective devices being any one or more out of: related to the user device or in the proximity of said location area. The server determines (204) a context based on time, location, and type of the additional data. Based on the determined context, the server identifies (205) whether or not gaps of data are required to be filled in relation to the requested location area and a time frame.—When no gaps of data are identified, the server decides (206) that the context and the additional data will be a first basis for creating a digital representation of the extended memory according to the request.—When gaps of data are identified, the server fills (207) the identified gaps with simulated data. The simulated data is simulated based on the determined context and the additional data and the received additional data. The server then decides (208) that context, the simulated data, and the additional data will be a second basis for creating a digital representation of the extended memory according to the request.

### TECHNICAL FIELD

Embodiments herein relate to a server and methods therein. In some aspects, they relate to handling an expanded memory associated with a user device in a communications network.

### BACKGROUND

In a typical wireless communication network, wireless devices, also known as wireless communication devices, mobile stations, stations (STA) and/or User Equipments (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

A lifelog in a user device, such as e.g. a UE, is a personal record of the user's daily life in a varying amount of detail, for a variety of purposes. The record comprises a comprehensive set of data of user's activities. The data may be used e.g. by a researcher to increase knowledge about how people live their lives. In recent years, some lifelog data has been automatically captured by wearable technology or mobile devices. People who keep lifelogs about themselves are known as lifeloggers, or sometimes lifebloggers or lifegloggers.

Lifelogging is part of a larger movement toward a “Quantified Self”, which is an application in devices that offers data-driven insights into the patterns and habits of the device users'lives. In recent years, some lifelog data has been automatically captured by wearable technology or mobile devices. These devices and applications record our daily activities in images, video, sound, and other data, which is improving upon our natural capacity for memory and self-awareness. They also challenge traditional notions of privacy, reframe what it means to remember an event, and create new ways to share our stories with one another.

### SUMMARY

As part of developing embodiments herein the inventors have identified a problem that first will be discussed.

### Key Event Detection and Classification

A Key event when used herein may e.g. mean an occurrence at a certain geographical or spatial location, at a certain moment in time, occasion, etc., together with certain persons such as e.g. significant other, family, kids, friends, pets, etc., specific non-personal objects, such as e.g. car, buildings, venues, etc., and/or achievements such as educational ones, birthdays, and e.g. environmental attributes such as weather conditions, temperatures, precipitation, rainfall, snow, etc. that are subject to be remembered by one concerned. E.g., based on captured media, iPhone Operating System (iOS) devices generate “For you—memories” that seems to be gathered in similar fashion. A key scene when used herein e.g. means according to previous outline of for first person rememberable constellations of persons, objects, venues and attributes. A key scene may consider a down-selection or subset of e.g. a specific person at a moment in time at a specific geographical location, identified as a specific event.

A set of rendered memory instances may be denoted as
“KidName #1-Spring 2022”, where e.g. KidName #1 has own user-specified entry in device's and/or cloud-located photo album.
“At the beach with KidName #2—through the years”.
“This day” as a birthday celebration for KidName #1, where the system has deducted that “something funny occurred” but did not deduct the specific type event at hand.
“Exploring Town X 2016” based on geolocation system resolves Town X, but did not resolve the potential key event as a family wedding.
“Days with snow 2018”, “KidName #1 and FriendName #1” given that both KidNAme #1 and FriendName #1 have individual entries in photo library, and that the plenty of snow (i.e. amount of white pixels) are identified.
Etc.

2019 Abeelen J. V., et al “Visualising Lifelogging Data in Spatio-Temporal Virtual Reality Environments” discusses a method for visualizations of lifelogging data in virtual reality. The method collects spatial and temporal metadata from images and creates map based 3d visualization. The user can access data based on time and locations which is shown on a map using multiple pins and layers. The method describes collecting the lifelogging data through various sensors.

WO2022099180A1 discloses image processing and analysis especially for vehicle images using neural network and artificial intelligence. Geolocation data is determined using family photographs with vehicles and virtually augmented data is generated. Users can virtually tour through places visited in past times, feel changes and experience time travel.

However, these documents only discloses that data from the device of user is collected. Further, memories are stored as pictures and movies or audio, taken from device perspective. It is not a collection of data from different devices that record the same event.

Smart glasses and other HMD (Head-Mounted Display) only cover a user's current Field of view (FoV), by collecting data from several devices you get a more complete picture of the situation.

A more complete memory would be achieved if data from other devices and servers were added.

An object of embodiments herein is to provide a way of expanding a memory associated with a user device and possibly an associated key event, in a communications network.

According to an aspect of embodiments herein, the object is achieved by a method performed by a server. The method is for handling an expanded memory associated with a user device in a communications network.

The server obtains a request related to the user device. The request is requesting to extend a memory according to a location area and a time frame.

The server receives additional data requested by the server. The additional data is related to the location area and the time frame and is received from one or more respective devices being any one or more out of: related to the user device or in the proximity of said location area.

The server determines a context based on time, location, and type of the additional data.

Based on the determined context, the server identifies whether or not gaps of data are required to be filled in relation to the requested location area and a time frame.
When no gaps of data are identified, the server decides that the context and the additional data will be a first basis for creating a digital representation of the extended memory according to the request.
When gaps of data are identified, the server fills the identified gaps with simulated data. The simulated data is simulated based on the determined context and the received additional data. The server then decides that context, the simulated data, and the additional data will be a second basis for creating a digital representation of the extended memory according to the request.

According to another aspect of embodiments herein, the object is achieved by a server configured to handle an expanded memory associated with a user device in a communications network. The server is further configured to:
Obtain a request related to the user device, requesting to extend a memory according to a location area and a time frame,
receive additional data requested by the server, which additional data is adapted to be related to the location area and the time frame, and is adapted to be received from one or more respective devices being any one or more out of: related to the user device or in the proximity of said location area, and
determine a context based on time, location and type of the additional date,
   based on the determined context, identify whether or not gaps of data are required to be filled in relation to the requested location area and a time frame, and
   when no gaps of data are identified, decide that the context and the additional data will be a first basis for creating a digital representation of the extended memory according to the request, and
   when gaps of data are identified, fill the identified gaps with simulated data based on determined context and the received additional data, and decide that the context, the simulated data and the additional data will be a second basis for creating a digital representation of the extended memory according to the request.

An advantage of embodiments herein is that the method allows a user device to create an extended digital representation of a memory by utilizing both its own data and additional data from devices in proximity. The additional data is then used to create a digital representation of the extended memory.

The method allows a digital representation of the extended memory to be created from incomplete data by using generative algorithms.

### BRIEF DESCRIPTION OF THE DRAWINGS

Examples of embodiments herein are described in more detail with reference to attached drawings in which:

FIG. 1 is a schematic block diagram illustrating embodiments of a communications network.

FIGS. 2a and 2b are a flowcharts depicting an embodiment of a method herein.

FIG. 3 is schematic block illustrating an embodiment herein.

FIG. 4 is a sequence diagram depicting embodiments of a method herein.

FIG. 5 is a sequence diagram depicting embodiments of a method herein.

FIG. 6 is a schematic block diagram depicting embodiments of a user device and a device.

FIG. 7 is a schematic block diagram illustrating embodiments of a server.

FIG. 8 schematically illustrates a telecommunication network connected via an intermediate network to a host computer.

FIG. 9 is a generalized block diagram of a host computer communicating via a base station with a user equipment over a partially wireless connection.

FIGS. 10-13 are flowcharts illustrating methods implemented in a communication system including a host computer, a base station and a user equipment.

### DETAILED DESCRIPTION

Examples of embodiments herein relate to expanding memories by merging data.

An example of a method according to embodiments herein may e.g. comprise the following.

A user device is instructed by its user to store a memory based on location and time. The memory may e.g. comprise a set of media and/or sensor readout into representation of a digital memorabilia. This may be performed manually or trigged by the user device and/or an external party.

The user device may specify a memory identifier and supply it together with the memory and specifications such as e.g. location, time frame etc., in a request to expand the memory and send it to a server, e.g. a cloud service.

The server receives a request from the user device. It may request captured data and additional data from the user device and additional data from devices in proximity to the location of the user device. The server merges the data from the user device and nearby devices, e.g. by performing sensor fusion, of the user device and/or other devices.

The server maps data to geographical positions and timeslots. The server may further determine geographical and time-related boundaries of the memory and what gaps in the data, if any, must be simulated within these boundaries.

The server inspects image data, sensor data and corresponding metadata to understand context, such as e.g., weather, type of event etc. It utilizes said context and the received data as input to a generative algorithm to fill gaps in data. The generative algorithm may also utilize data outside of the determined boundaries in this process.

A data structure including all data or all data within the determined boundaries, both collected and generated, and/or pointers to the data/database is sent to the user device. The data structure holds the digital representation of the extended memory and may e.g., be an extensive VR representation of the data.

Alternatively, it may also contain instructions on how to create a digital representation of the extended memory from the data.

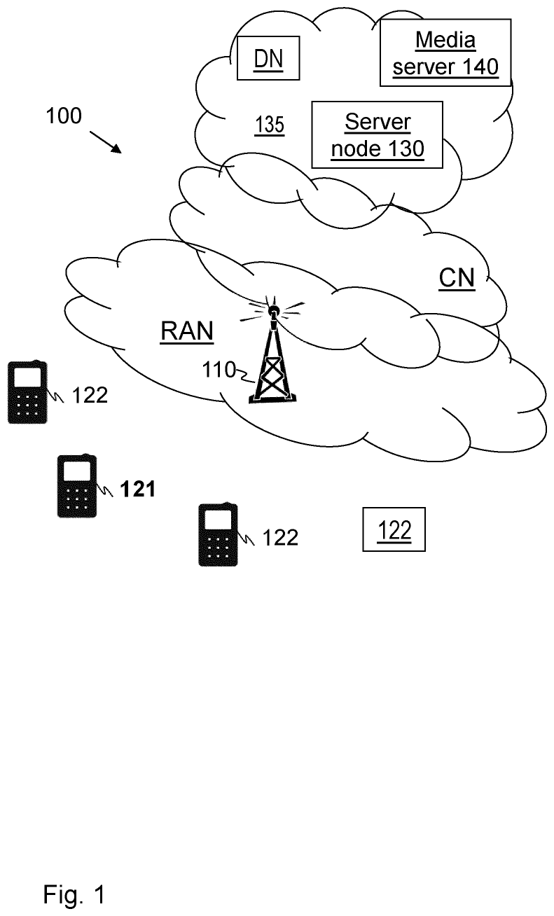

FIG. 1 is a schematic overview depicting a communications network 100 wherein embodiments herein may be implemented. The communications network 100 e.g. comprises one or more RANs and one or more CNs. The communications network 100 may use a number of different technologies, such as Wi-Fi, Long Term Evolution (LTE), LTE-Advanced, 5G, NR, Wideband Code Division Multiple Access (WCDMA), Global System for Mobile communications/enhanced Data rate for GSM Evolution (GSM/EDGE), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

E.g., a number of access points such as e.g. a network node 110 operate in communications network 100. These nodes provide wired coverage or radio coverage in a number of cells which may also be referred to as a beam or a beam group of beams.

The network node 110 may each be any of a NG-RAN node, a transmission and reception point e.g. a base station, a radio access network node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a device within the service area served by the network node 110 depending e.g. on the first radio access technology and terminology used. The network node 110 may be referred to as a serving network nodes and communicates with respective devices 121, 122 with Downlink (DL) transmissions to the respective devices 121, 122 and Uplink (UL) transmissions from the respective devices 121, 122.

Devices are operating in the communication network 100, such as e.g. the user device 121 and one or more devices 122. The user device 121 and the one or more devices 122 may each be represented by a computer, a tablet, a UE, a mobile station, and/or wireless terminal, capable to communicate via one or more Access Networks (AN), e.g. RAN, to one or more core networks (CN). The one or more devices 122 may be user devices or any kind of wireless or non-wireless communication device, e.g. a camera recording video from a football match.

It should be understood by the skilled in the art that “device” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

One or more servers operate in the communications network 100, such as e.g. a server 130. The server 130 e.g. handles e.g., controls, an expanded memory associated with the user device 121 according to embodiments herein. The server 130 may be comprised in any one out of: at least one cloud such as a cloud 135, a network node, at least one server node, the user device 121, an application in the user device 121, any of the devices 122.

Methods herein may be performed by the server 130. As an alternative, a Distributed Node (DN) and functionality, e.g. comprised in the cloud 135 as shown in FIG. 1, may be used for performing or partly performing the methods herein.

In some embodiments, the server 130 e.g., obtains data, also referred to as second additional data, from a media server 140, e.g., publicly accessible on the Internet. E.g., a non-real time source covering environment such as Google Streetview, etc.

Example of embodiments herein e.g., provides a method wherein the server 130 receives instructions to create a digital representation of an extended memory, described by e.g., time and location. The server 130 sends out requests for additional data such as e.g. image and sensor data correlating to the location and time frame. The requests may be sent e.g. to the user device 121, the devices 122, and the media server 140.

The server 130 merges received data and maps data to geographical positions and timeslots. The server 130 further determines the requested time and location boundaries for the representation of the memories and determines context. The server 130 further determines what gaps in the data, if any, must be filled by generated data to complete the representation within these time and location boundaries.

The server 130 e.g. uses a generative algorithm using the data as input to fill gaps with simulated data. This may e.g. be performed by using determined context and received data as input.

The method may e.g., be trigged manually by the user of the user device 121 or automatically by the user device 121 which detects a key event e.g. in sensor inputs and knowledge about context and user.

A number of embodiments will now be described, some of which may be seen as alternatives, while some may be used in combination.

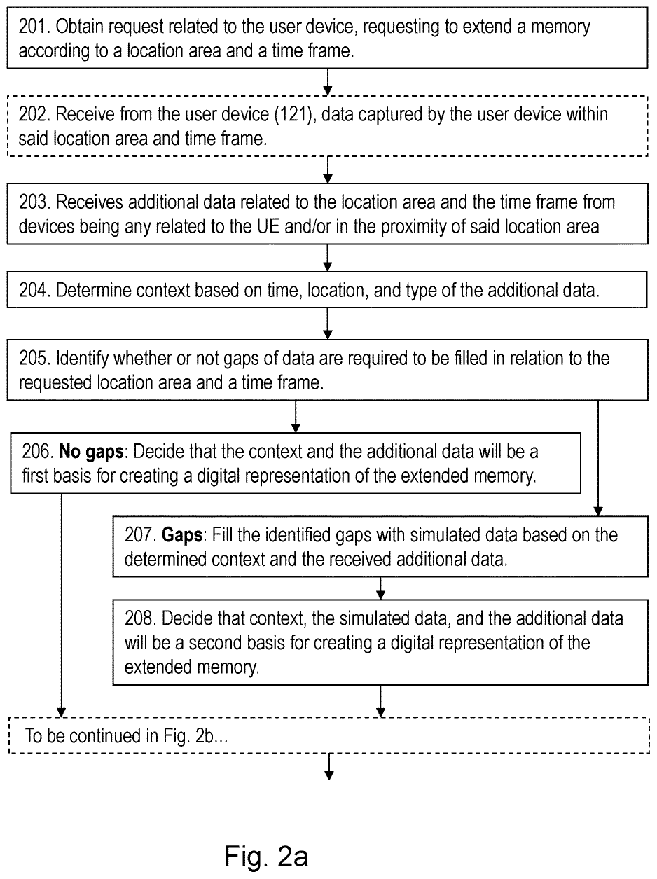

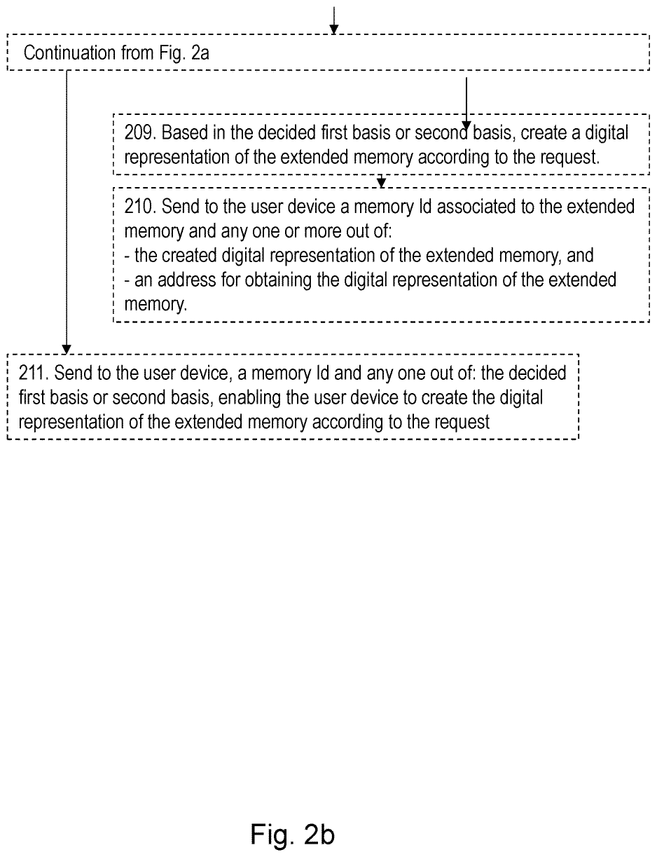

Embodiment herein will first be described in a more general way as seen from a perspective of the server 130 together with FIG. 2. This will be followed by examples and a more detailed description.

FIGS. 2a and 2b show example embodiments of a method performed by a server 130. The method is for handling an expanded memory associated with a user device 121 in a communications network 100. The server 130 may be comprised in any one out of:
the cloud 135, a network node, a server node, the user device 121, an application in the user device 121, any of the devices 122. An expanded memory, when used herein may mean a memory, such as collected or captured data from data sources such as devices, servers, etc. or a recording of sensor data related to the user device 121 that may be enhanced with additional information. The data may comprise image, video, audio, haptic, and or sensor data such as e.g. temperature, location, altitude, etc. It may be extended with more data than the user device 121 has itself. The expanded memory may further mean a recording of sensor data relating to one or more of the devices 122, of interest to a user of the user device 121, which may be enhanced with additional information.

Captured data when used herein refers to data captured by the user device 121 itself. Additional data when used herein refers to data received from other devices than the user device 121, such as the one or more devices 122 or from the media server 140.

The method comprises the following actions, which actions may be taken in any suitable order. Optional actions are referred to as dashed boxes in FIGS. 2a and 2b.

### Action 201

The server 130 obtains a request related to the user device 121. The request is requesting to extend a memory according to a location area and a time frame. The request is related to the user device 121. However, it may be received from the user device 121 or any other device or server, e.g., from a device 122 that knows that the user device 121 wishes an extended memory. This may be since the memory to be expanded relates to a key event such as e.g., to a calendar, mail, messages, or social media event of the user device's 121 user, which the other user device knows about.

In some embodiments, the request to expand the memory further comprises a memory Identifier (Id) associated with the memory to be expanded.

The obtaining of the request may be triggered by detecting an event, such as a key event related to the user device 121, to transform into a digital representation of extended memory. The key event may comprise one or more out of: a moment associated with a specific emotion, a sports highlight, a blooper, an achievement, a celebration, a media content of other users, a calendar event.

### Action 202

In some embodiments, the server 130 receives captured data from the user device 121. The captured data is captured by the user device 121 within said location area and time frame. The captured data may be comprised in the obtained request in Action 201.

The captured data may be related to any one or more out of: image data, video data, audio data, haptic data, sensor data, text data, object data scanned data such as Lidar, and metadata.

### Action 203

The server 130 receives additional data requested by the server 130. The additional data is related to the location area and the time frame. The additional data is received from one or more respective devices 122 being any one or more out of: related to the user device 121 or in the proximity of said location area. The one or more devices 122 may thus be related to the user device 121 or in the proximity of said location area.

The additional data may be related to any one or more out of: image data, video data, audio data, sensor data, text data, object data, and metadata.

The additional data requested by the server 130, may further comprise any one or more out of: first additional data from the user device 121, and second additional data from a media server 140.

### Action 204

The server 130 determines a context based on time, location and type of the additional data. A context when used herein may mean a definition of a time span, a location range, what type of event and what sensory inputs such as e.g., sight, hearing, vibrations, haptic feedback, scent/smell, light conditions, temperature, precipitation, large-scale environmental parameters such as celestial objects'status e.g., solar eclipse, moon new/full, etc. that the memory represents.

In some embodiments the determining of the context is further based on time, location, and type of the captured data.

### Action 205 Based on the determined context, the server 130 identifies whether or not gaps of data are required to be filled in relation to the requested location area and a time frame.

Depending on whether or not gaps of data are required to be filled, either Action 206 or Action 207 and 208 will be performed. When no gaps of data are identified action 206 will be performed. When gaps of data are identified, Action 207 and 208 will be performed.

### Action 206

When no gaps of data are identified, the server 130 decides that the context and the additional data will be a first basis for creating a digital representation of the extended memory according to the request.

The wordings “first basis” and “second basis” are used herein to differentiate the different basis to be used for creating a digital representation depending on whether or not any simulated data to fill any gaps shall be included in the basis.

The first basis comprises the context, the additional data and possibly captured data, and will be used as a basis if no gaps of data are identified.

The second basis comprises the context, the simulated data, the additional data and possibly captured data, and will be used as a basis if gaps of data have been identified and filled with simulated data. This will be described below in action 208.

The creating of the digital representation of the extended memory according to the request herein may comprise creating a three dimensional (3D) world of the extended memory based on the decided first basis, or second basis.

In some embodiments wherein the determining of the context is further is based on time, location, and type of the captured data. In these embodiments the captured data is further comprised in the first basis.

### Action 207

When gaps of data are identified, the server 130 fills the identified gaps with simulated data based on determined context and the received additional data and the captured data if any. The simulated data may be created using user defined parameters defining, for example, weather or lighting conditions.

This will be described more in detail below.

### Action 208

The server 130 decides that the context, the simulated data, and the additional data will be a second basis for creating a digital representation of the extended memory according to the request.

In some embodiments the determining of the context is further based on time, location, and type of the captured data. In these embodiments the captured data is further comprised in the second basis.

### Action 209

In some embodiments, based in the decided first basis or second basis, the server 130 creates the digital representation of the extended memory according to the request.

A digital representation of the extended memory when used herein may mean a collection of additional data, captured data and simulated data which belong to the defined context. The data may comprise data relating to several senses, e.g., to create an immersive VR experience for the user, image data may further have been transformed from a two-dimensional to a three-dimensional domain.

“Based on the decided first basis or second basis” means that the creation of the digital representation is based on the outcome of whether or not gaps of data are required to be filled. When no gaps of data are identified, the first basis will be used for creating a digital representation of the extended memory. When gaps of data are identified, the second basis will be used for creating a digital representation of the extended memory.

### Action 210

In these embodiments, the server 130 sends to the user device 121, the memory Id associated to the extended memory and any one or more out of:
the created digital representation of the extended memory, and
an address for obtaining the digital representation of the extended memory.

### Action 211

In some alternative embodiments, the server 130 sends to the user device 121, the memory Id and any one out of the decided first basis and second basis. The decided first basis or second basis enable the user device 121 to create the digital representation of the extended memory according to the request.

The above embodiments will now be further explained and exemplified below. The embodiments below may be combined with any suitable embodiment above.

### General Embodiments

Some examples of general embodiments provide a method to extend user memories of a user of the user device 121, by merging internal data from the user device 121, and external data from the devices 122 and possibly at least one media server 140. E.g., by merging data from both internal and external sensors. The sensors may e.g. be camera, microphone, Inertial Measuring Unit (IMU), light sensor, humidity sensor, accelerometer, Gazing/FOV sensors, “skin scanning” to perhaps fetch aspects where e.g. fingerprint readers/TouchID is considered for some sensorial input.

External sensors may include “environmental inputs” such as air/gas constellations (apart from air humidity), celestial objects (moon, sun, etc.). The goal is to create a digital representation of the extended memory where the user of the user device 121 is able to experience aspects of the memory not captured in the data from the user device 121. A digital representation of the extended memory may be embodied as a 3D world which may be experienced by the user, e.g., in Virtual Reality (VR).

In some examples of the general embodiments, the user of the user device 121 manually instructs the user device 121 to capture a memory which is to be expanded and supplies it as captured data to the server 130. The server 130 performs the merging of data from different sensors from the user device 121, devices 122 and media server such as e.g., camera, microphone, Inertial Measuring Unit (IMU), light sensor, humidity sensor, accelerometer, the user device 121 and the devices 122 as well as generates missing data. Variants where the trigger is automatic and/or takes place within the user device 121 is described in further embodiments.

The server 130, may or may not be comprised in a cloud environment such as the cloud 135, but due to the computational requirements added by the merging and generative algorithms, a cloud implementation i.e., the server 130 being represented by one or several servers, is an advantageous embodiment. The server 130, may further be implemented in the user device 121.

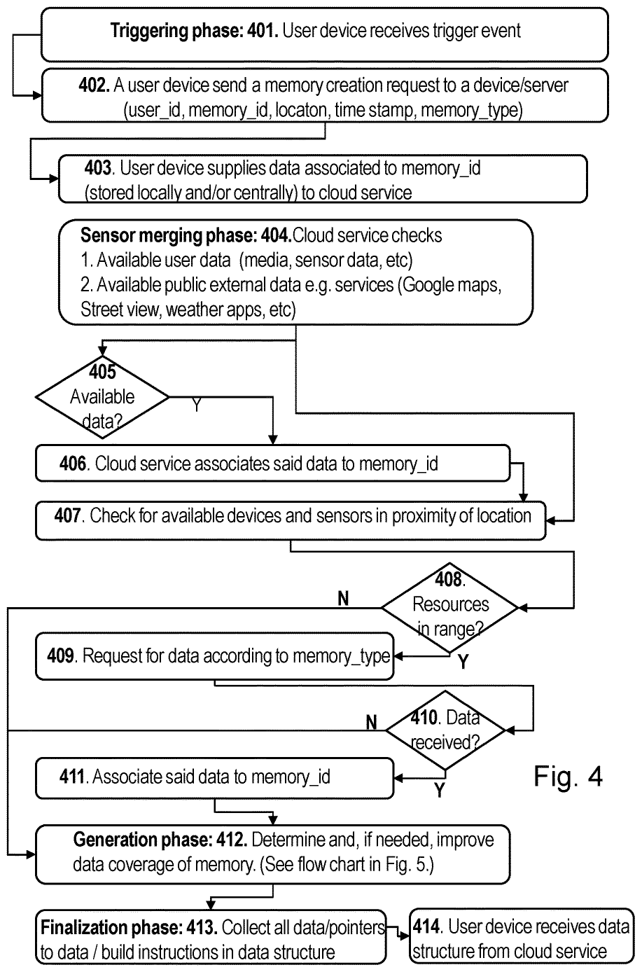

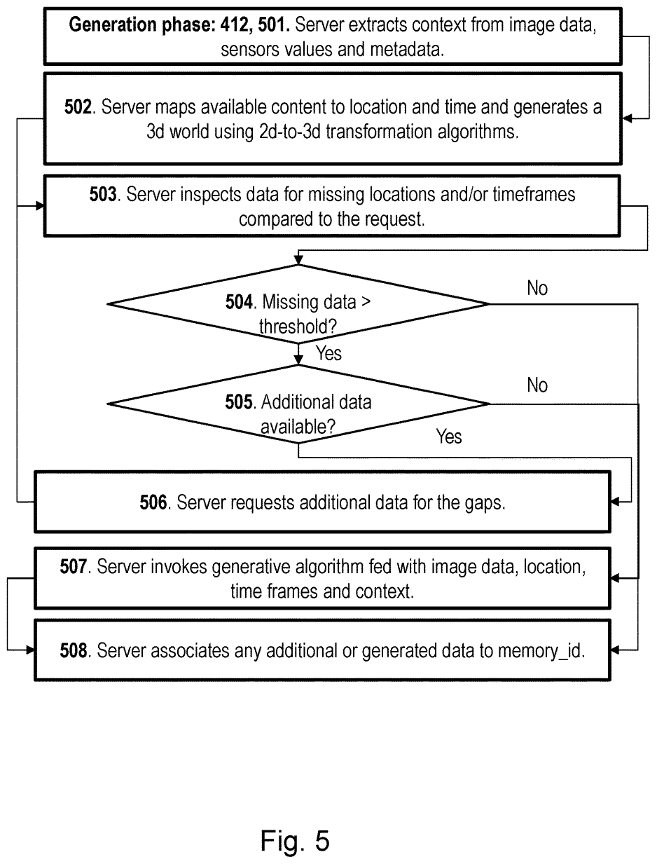

Embodiments herein may be described in four distinct phases: triggering, data merging, generation and finalization. These phases are illustrated in a flow chart of FIG. 4 and the generation phase in detail in FIG. 5, which will be described later on.

### Triggering

The triggering relates to and may be combined with Action 201 described above. When it is indicated in the user device 121 that a memory should be stored, the user device 121 sends out a request to the server 130 to expand, also referred to as extend, the memory within a certain time frame, also referred to as timespan, and geographic area.

The request, e.g., comprising a memory id, a location area, a time frame, a type etc., is supplied to the server 130. The request is requesting the server 130 to expand a memory according to a location area and a time frame.
The location area may e.g. describe a specific location and radius which should be covered, or an area, e.g. everything between the location points X, Y, and Z should be captured.
The time frame may describe a specific point in time or if the memory should cover a longer sequence.
The type may describe the context of the memory, e.g., football game, a party, a graduation, a prize ceremony, the first flower in spring, your child's first steps, and e.g.

what is important in the memory, e.g. a person, an event, an object, a certain constellation of feeling e.g. “a full day of happiness”.

### Merging Received Data

This relates to and may be combined with Actions 202 and 203 described above.

The server 130 receives request from user device 121. The server 130 may respond by sending a request for any captured data or additional data the user device 121 may have covered relating to the requested location area and time frame. This may also be sent during the trigger phase, e.g. in the request from the user device 121. If relevant, the server 130 may further collect data from other services storing static data of the location area, such as the media server 140, e.g., being represented by Google Streetview, Instagram, Snapchat, etc.

The server 130 requests additional data from the devices 122 in proximity to the user device 121 or a location associated with the intended memory aggregation. To find which devices are in proximity, several different ways may be used. E.g., utilizing operator data to find additional devices willing to share data, the additional devices having a certain application on the device or the additional devices explicitly responding to request from the server 130.

Once the server 130 has determined which devices 122 have been in proximity of the location determined by the user device 121, the server 130 requests data from determined devices.

The server 130 may then receive one or more of the following data:
Image and video input from user device 121, referred to as captured data.
Image and video input from the devices 122 referred to as additional data.
Image and video from non-real time sources covering environment, e.g. Google Streetview, etc., referred to as additional data from the media server 140.
Sensor data from user device 121 and additional devices, e.g. indicating humidity, light intensity, color, sound and spectral attributes, temperature, IMU data, haptic data etc. referred to as captured data and additional data,
Metadata for the data/device. referred to as captured data and additional data.
Object data relating to persons and/or physical objects present in the memory.

The server 130 analyzes all received data and determines the context of the memory to be expanded based on time, location, and type of the additional data and in some embodiments the captured data. The server 130 associates all received data with the memory id.

### Generation

This relates to and may be combined with Actions 204-208 described above. The server 130 uses the received metadata for each device, such as the user device 121 and the one or more devices 122, to determine where each piece of data fits in. The received metadata may be comprised in the additional data and the captured data, and may e.g. comprise geolocation, timestamp, direction and velocity/motion vector.

Depending on the collected captured data and additional data and parameters comprised in the request, the server 130 determines the context e.g. the boundaries, also referred to as limits or edges, of the memory to be expanded, e.g., where the “world” that should be constructed ends. This is compared with the requested location area and a time frame. The memory to be expanded is here thus represented by the “world” that should be constructed. Any of the received additional data that is falling outside of the requested location area and a time frame, e.g. the “world” is discarded.

The server 130 may determine objects, such as e.g. car, person, pets, etc., and environment such as e.g., sunshine, full moon, green grass, cloudy sky, rainfall, in the received captured data and the additional data, and their placement relative to each other. This step may be performed by the server 130 by using an objection detection algorithm.

The server 130 may determine and generates a 3D world from the received captured data and the additional data, e.g., image data, and object placement. Transforming two dimensional (2D) images to 3D images is known in the art and may be used here. Also, spatial sound may be added as well as scent and taste if that is relevant. The 3D world may be a single moment in time or a time frame.

The server 130 further identifies gaps based on the context. The gaps may then be time periods and/or location areas where data is missing, i.e., where no data has been received. A gap may furthermore specifically consider a certain individual, specific object, and/or environment attributes, etc. being missing.

The server 130 may further determine if there are additional device's which may be queried for data belonging to the gaps.

Optionally, the server 130 may request any device currently in proximity of the location to record new data of missing segments, to increase the ability to recreate the missing segments.

The server 130 fills the gaps with simulated data based on determined context and the received additional data. The server 130 may use a generative algorithm with closely related world segments as input to generate data. An example of such a generative algorithm is a Generative Adversarial Network, such as “Boundless: Generative Adversarial Networks for Image Extension”, Teterwak et al., ICCV 2019.

For example, if data is missing between two image segments, the algorithm may be fed with the enclosing data and generate new data based on this input. The algorithm may also be trained on additional input, such as context keywords.

In another approach, generative rendering may consider audio, where for example it is determined that a music tune is played in time segments A, B and D, but is missing for the in-between segment C, which then may be “patched” by selecting the music segment for C as the part between “B” and “D” in the identified full segment.

The generated simulated data is associated with the memory id.

### Finalization

This relates to and may be combined with Actions 209-211 described above.

In some embodiments, the server 130 fully generates a digital representation of the extended memory with the associated memory id, based on the context, the additional data, the captured data, and the simulated data if any. The server 130 then sends the expanded memory to user device 121, e.g., if a memory completeness metric exceeds a threshold.

Alternatively, if the memory completeness metric is less than a threshold, the server 130 may notify the user device 121 that the memory could not be assembled and thus not be expanded according to the request. The server may provide information to the user device 121 about the media parts that are missing, for example as information for the user of the user device 121.

Alternatively, the extended memory is not supplied, but instead the server 130 sends an address for obtaining the digital representation of the extended memory. E.g., the server 130 may store the digital representation of the extended memory in the server 130 and send an address to user device 121.

In a further alternative, the server 130 sends to the user device 121, the context, the additional data, the captured data, and the simulated data if any, which enables the user device 121 to create the digital representation of the extended memory according to the request. E.g., the server may send instructions to the user device 121, on how to create the digital representation of the extended memory from the data.

### Automatic Triggering Mechanism

In some embodiments, the user device 121 and/or a server 130 automatically detects key events to transform into digital representations of extended memories. Embodiments herein may further comprise a method operative in the user device 121 and/or server 130, that:
Continuously gathers and temporarily stores captured data and/or additional data such as e.g. imagery and/or sensor data. Captured data originating from user device 121 may be stored temporarily in user device 121 and/or in cloud server in the cloud 135 and/or in the server 130.
Detects and classifies key events in media content for the user of the user device 121. The media content when used herein may e.g. mean images, videos, audio recordings, sensor recordings. The key events may e.g. be a happy moment, a soccer goal, a blooper, an achievement, a celebration, a sad moment, etc. Potentially also key-events for other users detected in media content. These may be found by instructing the server 130 to create a memory when a certain person looks very happy for example.
Determines presence of a use key event of type K.
Determines start, stop and duration of key event of type K.

For a first key-event detected for the user of the user device 121, the server 130, an application running in the user device 121 and/or the server 130 may then:
Associate the data such as e.g., media data and/or sensor data, or data recorded by user device 121, to suit to a memory such as a user key memory entity in the user device 121. This captured or recorded data may e.g. be text messages, web-pages, application status or contextual information. The application may e.g. compile Memory X=[UserKeyEventTag; media data; sensor suit data].
Associate also adjacent other devices'122 media data and/or sensor data to the memory such as a user key memory entity in the user device 121. This may e.g. be any one or more out of: text messages, web-pages, application status, contextual information, etc. obtained from external devices, person and/or object information, environment information, temperature, humidity, light-and acoustical attributes, etc.
Apply data management actions for determined not in User Key Event (not-in-UserKeyEvent) media data, e.g. after timer expiration, user ACK, etc. This said not-in-UserKeyEvent media data, referred to as data below, may be denoted as less interesting and/or excess information, where “a managing action” may consider steps of:
   Move data from primary work storage and/or memory to secondary long-term storage.
   Compress data in any of primary or secondary storage
   Down-sample time-resolution of data in any of primary or secondary storage.
   Remove data from temporary storage.
   Provide other contributing devices and/or managing server with user key event information for any respective key event classification actions associated with their managed users, such as e.g.:
      Considered user of the user device 121
      Event type and attributes, such as start/stop and duration.
      Data management actions for determined not-in-UserKeyEvent, not considering “data remove”, and e.g. link and/or address for said data.

### Key Event Classification

A so-called key event may in practice differ from user to user and is typically context-based. Often, however, there are likely some common denominators. For example, birthdays are often associated with textual expressions such as “happy birthday”.

A first device and/or managing server, such as the user device 121 or server 130, may use image and/or object detection or recognition and text interpretation, to further identify presence of any one or more out of the following:
Keywords such as “Happy Birthday”, “Seasons greeting”, “Happy New year” textually or by text recognition determined as expressed in media stream.
Key-objects such as “symbols”, “gift wrappings”, flower/decorations, such as Santa Claus, Eastern Bunny, or alike.
Key-facial expressions for at least a first person. This may e.g. be the user of the user device 121. The Key-facial expressions may further be potentially fraction of a second person, or for a third person being present in a media stream. The Key-facial expressions, may e.g. relate to “happy”, “surprised”, “sad”, “anger”, etc.
Method's observation: Face associated with “first person” associated “happiness” associated with body posture “hands put on” associated with “gift box” associated with “text: happy birthday”.
Method's conclusion: “First person <determined 96 %>opens birthday gift <object text recognition 92 %>and seems happy <estimated emotion metric [happy, sad, anger]=[90%, 6%, 4%]>” Action: classify detected as user event key event K.
The first user application and/or managing server, such as the user device 121 application or the server 130, may fail to determine type of (key) event based on available information in first user's data repositories. In this case the server 130 may then either by means of the application e.g. triggered based on lack of key-event detection success in device processing, or manually from user upon determination of missing and/or faulty previous key-event, etc. perform the following.
   The server may request other devices 122 also in control by the server 130, for a potential tagging of “some yet undetermined” event. The event may be e.g., be for any one or more out of date, hours, locality, media content, media attributes, context, or face metrics. The managed devices 112 may be identified based on relations, e.g. friends, family, contacts, etc. available by entries in medias, text/mail messages, social platforms, etc., to the user device 121.

The server 130 may respond to requesting first device application/server process such as the user device 121 with list of suggested, to be verified, event classifications obtained from other devices and/or users. The first device application, such as the user device 121, may evaluate the probability for suggested event tagging to be valid for first user, e.g. by comparing any of the following:
A face metric for e.g. selected individuals, geo-locality, time, etc.
Known social contact to the user of the user device 121 in the same media stream, and media tagged as FirstUserCelebrationX by social contact→classified as high relevance→Suggested as key-event FirstUserCelebrationX.
Context attributes, such as “a dog is present, but the user of the user device 121 is know from medical data to be allergic to dogs”→the event is classified lower relevance.
Date, hours, locality] with events provided by external other/event managing servers, e.g. the following: Opening Session Team A (OpeningSessionTeamA) at arena Z (arenaZ), and attributes in first media and external media aligns, i.e. non-personal key-events, such as sports event, concert, etc.

The first device application, e.g. the user device 121 or the server 130, may have at least one candidate User Key Event (UserKeyEvent) determined for a certain media for a certain user obtained based either on first device and/or other device data. The application, e.g. the server 130, may assign a probability value, e.g. between low and high, for the event classification depending on estimated accuracy obtained during said event classification.

### Key Event Classification for Second User

First device application may likewise determine a user key event for a second user, i.e. other person than first but still detected in media stream, then:
The server 130 may assign a probability value (low . . . high) for said event classification depending on estimated accuracy of event classification in first (and/or requested) device
The server 130 may push to the device 121 a request to provide a determined SecondUserKeyEvent.
The second user device may respond with ACK and receive proposed Second User Key Event (SecondUserKeyEvent), determine if key_event_classification_probability >a threshold (based on face metric, shape, motion patterns (video) etc.) and assume the received suggestion for SecondUserKeyEvent as FirstUserKeyEvent per of the user device 121 such as the first device application.

### Further Embodiment—User—Selected Level of Memory-Assimilation Details

In one aspect of embodiments herein, the user device 121 may provide in the request to the server 130, an indication indicating on which levels of details the digital representation of the extended memory should target.

In one exhaustive setting, the user device 121 may in the request, request for a complete, in terms of all accessible sensors, aggregation of media data with a gap-free timeline. Following that, a full requirement given a sparse available sensor time availability may require more gap-filling rendering by the server 130.

The user device 121 may also provide a prioritization list to the server 130, e.g. suggesting system to first aggregate data from sensors of type A, then from type B, etc.

User device 121 setting may also consider requirement or targeted time-continuity, such as “gap free”, time gaps <5 min, time gaps <30 min, etc.

Prioritization of sensor data may also consider the context the memory is rendered for, e. g, what other persons that are present, considered environment, type of memory such as e.g. a concert, a birthday, etc.

A default setting may consider a length of a targeted event, e.g., event spanning full day, or a one hour long birthday party for kids, or other aspects of the context.

### Further Embodiment—Change Certain Parameters in Memory

In one embodiment, the user device 121 may further request the server 130 to alter the data using certain parameters. E.g., transforming the digital representation of the extended memory into nighttime or sunny instead of raining.

### Further Embodiment—Function Within User Device 121

In one embodiment, the server 130 may be omitted and instead implemented within the user device 121. In such a scenario, the service may be embodied as a computer program or application running on the user device 121.

### Further Embodiment—Mechanism for Selecting and Triggering a Memory Compilation

In the steps of the server 130 being instructed to expand a memory, that would typically as indicated above, be triggered manually by the user of the user device 121, periodically by the server 130, e.g. the device application, or as triggered by a user key event.

Rendering of a “personal memory” associated with an external type of key event may further be considered. For example, given a historical entry such as “moon landing”, natural disaster X, system may via interface to external servers, e.g. news, social media platforms, etc., obtain information for the system to evaluate as candidates for another type of key event types, despite user typically not participating in that chain of event.

With that embodiment, a user device 121 may be provided with personal memory aggregations associated with world key events, such as “During the landing at planet Mar. 2029 Jun. 7 12:34 CET—you were doing . . . ”

### Further Embodiment—Memory as an Immersive Environment

In a further aspect, if a collected memory id data comprises 360-degree imagery and or combined with e.g. Google Streetview data then the server 130 may generate an immersive environment that a user can visit afterwards via VR, XR.

The server 130 may determine if the imagery sufficiently, e.g. is exceeding a threshold, represents the scene of the memory. For example, sufficient imagery that allows the server 130 to fill in the gaps, based on said image data.

Also, additional data may be applied to the immersive environment scene, e.g. background sounds, such as, people talking/cheering, and additional sensor data like smells/scents, tastes, haptic feedback, etc.

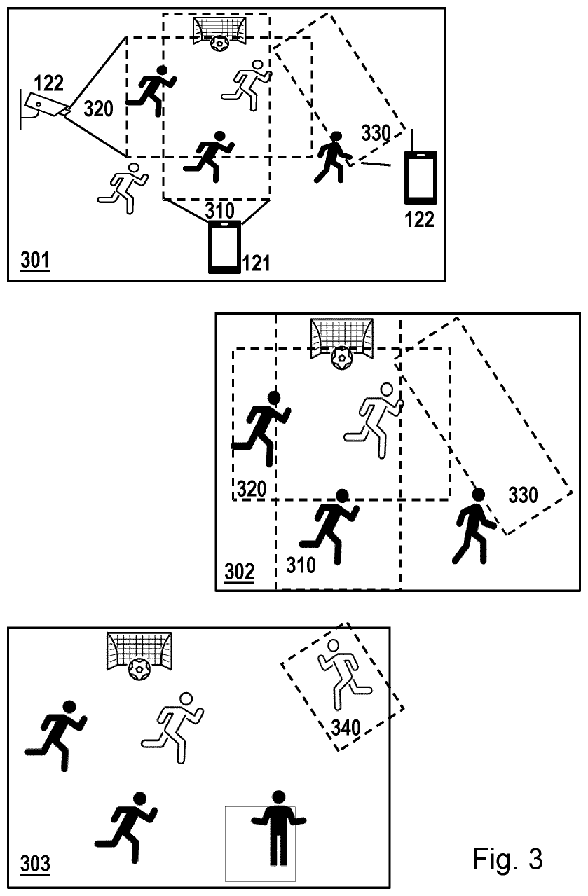

FIG. 3 illustrates an example of steps 301-303 according to some embodiments herein relating to the actions described above. In this example the memory to be expanded relates to a football match.

In a first step 301, captured data 310 data from the requesting user device 121 and additional data 320, 330 from several different sources, such as the devices 122 are collected by the server 130. In this example one device 122 is represented by a user device and one device 122 is represented by a camera device.

In a second step 302, captured data 310 and additional data 320, 330 are mapped to locations and time frames, and the server 130 determines if any data is missing within the location area or time frame requested by the user device 121.

In a third step 303, any gaps in the data are filled with simulated data 340 by a generative algorithm taking collected data and other context information as input.

FIG. 4 is a flow chart that illustrates the different phases and how they are related to each other according to an example of some embodiments herein. The below steps are examples of, relate to and may be combined with the actions described above.

Triggering Phase: 401. The user device 121 receives trigger event.
402. The user device 121 sends to the server 130, a request to extend a memory according to a location area and a time frame. E.g. a memory creation request comprising a user id, a memory id, a location, a time stamp, and a memory type.
403. The user device 121 supplies to the server 130, data associated to the memory id, e.g. stored locally and/or centrally.

Sensor merging phase: 404. The server 130 checks for available user data such as e.g. media, sensor data, etc. and available public external data such as services, e.g. Google maps, Street view, weather apps, etc.
405 The server 130 inspects data that is available.
406. If data is available the server 130 associates said data to the memory id.
407. The server 130 checks for available devices with sensors 122 in, or in the proximity, of the location mentioned in the request.
408. If available, server proceeds to 409, else it proceeds to 412.
409. If resources are available the server 130 requests these resources for additional data according to the memory type.
410. The server 130 checks if any additional data is received.
411. If any additional data is received from said resources, the server 130 associates said additional data to the memory id.

Generation phase: 412. The server 130 determines and, if needed, improves the data coverage of the memory. See separate flow chart in FIG. 5.

Finalization phase: 413. The server 130 creates a digital representation of the extended memory according to the request, e.g. by collecting all data or pointers to the data, referred to as first and second basis above, or builds instructions in data structure. Build instructions being directives which the user device 121 may follow to assemble the extended memory locally.
414. The user device 121 receives the digital representation of the extended memory such as e.g. the data structure from server 130.

FIG. 5 is a flow chart that illustrates the generation phase more in detail according to an example of some embodiments herein. The below steps are examples of, relate to and may be combined with the actions described above.
Generation phase: 501, referred to as Step 412 above. The server 130 extracts context from the captured data and the additional data such as e.g. image data, sensors data, e.g. sensor values and metadata.
502. The server 130 maps available content to location and time and determines a context based on time, location, and type of the additional data and captured data if available, e.g. by generating a 3D world using 2D-to-3D transformation algorithms. Step may also be performed after step 509 in some embodiments.
503. Based on the determined context, the server 130 identifies whether or not gaps of data are required to be filled in relation to the requested location area and a time frame, e.g. by inspecting data for missing locations and/or timeframes compared to the request. 504. The server 130 checks if the missing data exceed a threshold relating to e.g., geographic coverage or time coverage.
505. The server 130 checks if any further additional data is available.
506. If any further additional data is available, the server 130 requests additional data for the gaps.
507. If no further additional data is available, the server 130 fills the identified gaps with simulated data, e.g. by invoking a generative algorithm to fill the memory using image data, location, time frames and context as input.
508. The server 130 associates any additional and/or generated data with the memory id.

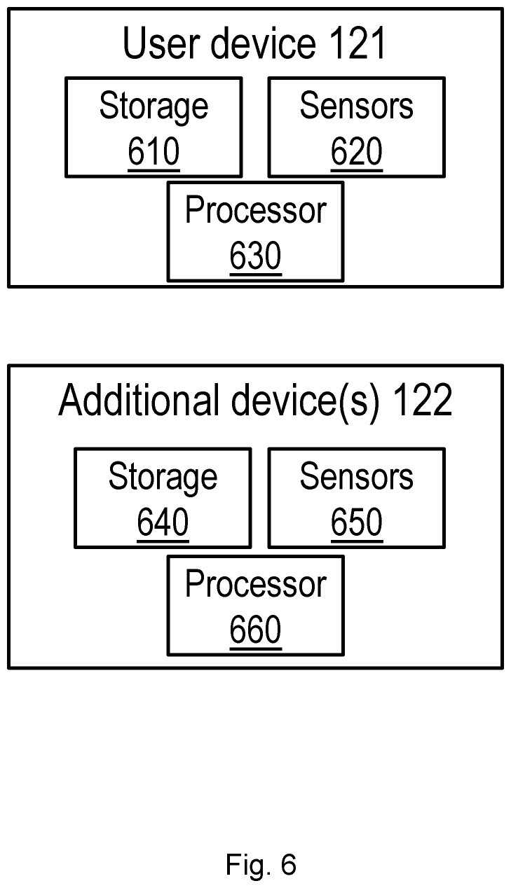

The user device 121 and components in the user device 121 that may be involved in the method according to embodiments herein are shown in FIG. 6.

The components in the user device 121 may e.g. comprise a storage 610, sensors 620, and a processor 630.

Further, an example of the device 122 and components in the device 122 that may be involved in the method according to embodiments herein are shown in FIG. 6.

The components in the devices 122 may e.g. comprise a storage 640, sensors 650, and a processor 660.

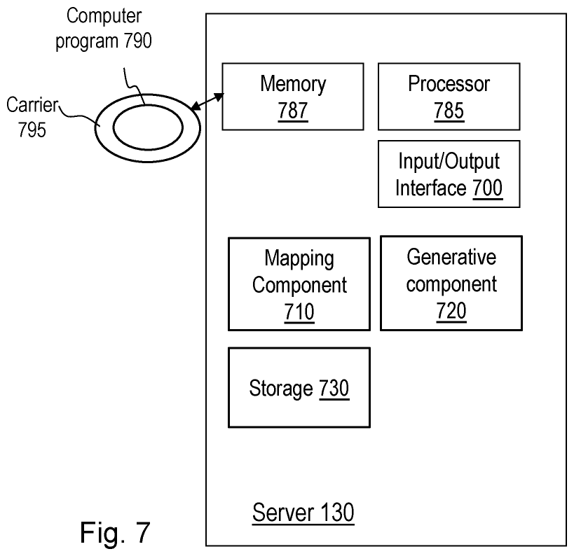

To perform the method actions above, the server 130 is configured to handle an expanded memory associated with a user device 121 in a communications network 100. The server 130 and components in the server 130 that may be involved in the method according to embodiments herein are shown in FIG. 7. The server 130 may comprise an arrangement depicted in FIG. 7.

The server 130 may comprise an input and output interface 700 configured to communicate with network entities such as e.g., the user device 121 and the one or more devices 122. The input and output interface 700 may comprise a wireless receiver not shown, and a wireless transmitter not shown. The components in the server 130 may e.g. comprise a mapping component 710 configured to perform the mapping of captured data and additional data to locations and time frames for determining the context, a generative component 720 configured to perform the generation and finalization of the digital representation of the extended memory, and a storage 730 for storing the digital representation of the extended memory.

The server 130 is further configured to:
obtain a request related to the user device 121, requesting to extend a memory according to a location area and a time frame,
receive additional data requested by the server 130, which additional data is adapted to be related to the location area and the time frame, and is adapted to be received from one or more respective devices 122 being any one or more out of: related to the user device 121 or in the proximity of said location area, and
determine a context based on time, location and type of the additional data,
based on the determined context, identify whether or not gaps of data are required to be filled in relation to the requested location area and a time frame, and
   when no gaps of data are identified, decide that the context and the additional data will be a first basis for creating a digital representation of the extended memory according to the request, and
   when gaps of data are identified, fill the identified gaps with simulated data based on determined context and the received additional data, and decide that the context, the simulated data and the additional data will be a second basis for creating a digital representation of the extended memory according to the request.

The server 130 may further being configured to:
receive captured data from the user device 121, which captured data is adapted to be captured by the user device 121 within said location area and a time frame, and wherein
the server 130 is configured to determine the context further based on time, location, and type of the captured data, and
the captured data further is adapted to be comprised in the respective first basis and second basis.

The request to expand the memory may further be adapted to comprise a memory Identifier, Id, associated with the memory to be expanded, and wherein the server 130 further is configured to:
based in the decided first basis or second basis, create the digital representation of the extended memory according to the request, and
send to the user device 121 the memory Id associated to the extended memory and any one or more out of:
   the created digital representation of the extended memory, and
   an address for obtaining the digital representation of the extended memory.

The request to expand the memory may further be adapted to comprise a memory Identifier, Id, associated with the memory to be expanded. The server 130 may then further be configured to:
send to the user device 121, the memory Id and any one out of: the decided first basis or second basis, which decided first basis, or second basis are adapted to enable the user device 121 to create the digital representation of the extended memory according to the request.

The respective captured data and additional data may be adapted to be related to any one or more out of image data, video data, audio data, sensor data, text data, object data, and metadata.

The additional data requested by the server 130 may further be adapted to comprise any one or more out of first additional data from the user device 121, and second additional data from a media server 140.

The obtaining of the request may be adapted to be triggered by a detecting of a key event related to the user device 121, to transform into a digital representation of extended memory. The key event may be adapted to comprise any one out of: a moment associated with a specific emotion, a sports highlight, a blooper, an achievement, a celebration, a media content of other users, a calendar event.

The creating of the digital representation of the extended memory according to the request may be adapted to comprise: Creating a three dimensional (3D) world of the extended memory based on the decided first basis, or second basis.

The server 130 may be adapted to be comprised in any one out of: a cloud, a network node, a server node, the user device 121, an application in the user device 121, any of the devices 122.

The embodiments herein may be implemented through a respective processor or one or more processors, such as the processor 785 of a processing circuitry in the server 130 depicted in FIG. 7, together with respective computer program code for performing the functions and actions of the embodiments herein. The program code mentioned above may also be provided as a computer program product, for instance in the form of a data carrier carrying computer program code for performing the embodiments herein when being loaded into the server 130. One such carrier may be in the form of a CD ROM disc. It is however feasible with other data carriers such as a memory stick. The computer program code may furthermore be provided as pure program code on a server and downloaded to the server 130.

The server 130 may further comprise a memory 787 comprising one or more memory units. The memory 787 comprises instructions executable by the processor in the server node 130. The memory 787 is arranged to be used to store e.g., monitoring data, information, indications, data such as captured data, additional data and simulated data, configurations, and applications to perform the methods herein when being executed in the server 130.

In some embodiments, a computer program 790 comprises instructions, which when executed by the respective at least one processor 785, cause the at least one processor of the server 130 to perform the actions above.

In some embodiments, a respective carrier 795 comprises the respective computer program 790, wherein the carrier 795 is one of an electronic signal, an optical signal, an electromagnetic signal, a magnetic signal, an electric signal, a radio signal, a microwave signal, or a computer-readable storage medium.

Those skilled in the art will appreciate that the units in the server 130 described above may refer to a combination of analog and digital circuits, and/or one or more processors configured with software and/or firmware, e.g. stored in the server node 130, that when executed by the respective one or more processors such as the processors described above. One or more of these processors, as well as the other digital hardware, may be included in a single Application-Specific Integrated Circuitry ASIC, or several processors and various digital hardware may be distributed among several separate components, whether individually packaged or assembled into a system-on-a-chip SoC.

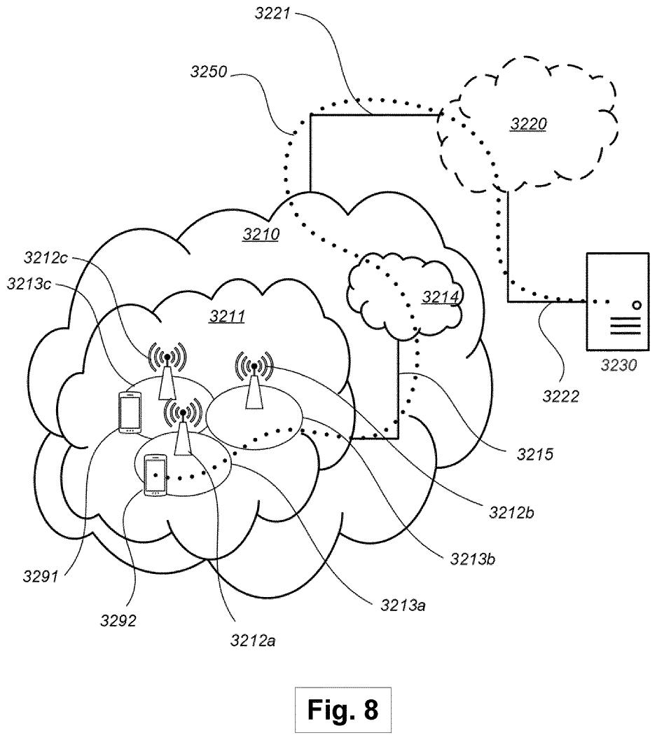

With reference to FIG. 8, in accordance with an embodiment, a communication system includes a telecommunication network 3210, such as a 3GPP-type cellular network, e.g. communications network 100, which comprises an access network 3211, such as a radio access network, and a core network 3214. The access network 3211 comprises a plurality of base stations 3212a, 3212b, 3212c, such as AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as a Non-AP STA 3291 located in coverage area 3213c is configured to wirelessly connect to, or be paged by, the corresponding base station 3212c, e.g. the user device 121. A second UE 3292 such as a Non-AP STA in coverage area 3213a is wirelessly connectable to the corresponding base station 3212a e.g. the second device 122. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 8 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

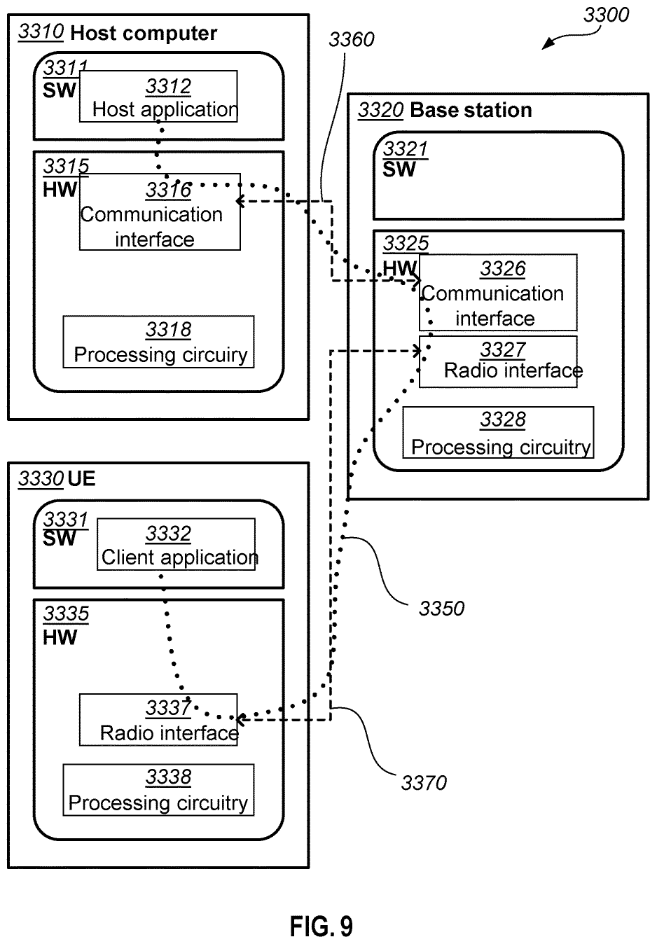

Example implementations, in accordance with an embodiment, of the UE, base station and host computer discussed in the preceding paragraphs will now be described with reference to FIG. 9. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 20) served by the base station 3320. The communication interface 3326 may be configured to facilitate a connection 3360 to the host computer 3310. The connection 3360 may be direct or it may pass through a core network (not shown in FIG. 9) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 9 may be identical to the host computer 3230, one of the base stations 3212a, 3212b, 3212c and one of the UEs 3291, 3292 of FIG. 8, respectively. This is to say, the inner workings of these entities may be as shown in FIG. 9 and independently, the surrounding network topology may be that of FIG. 8.

In FIG. 9, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the latency and user experience and thereby provide benefits such as reduced user waiting time, better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

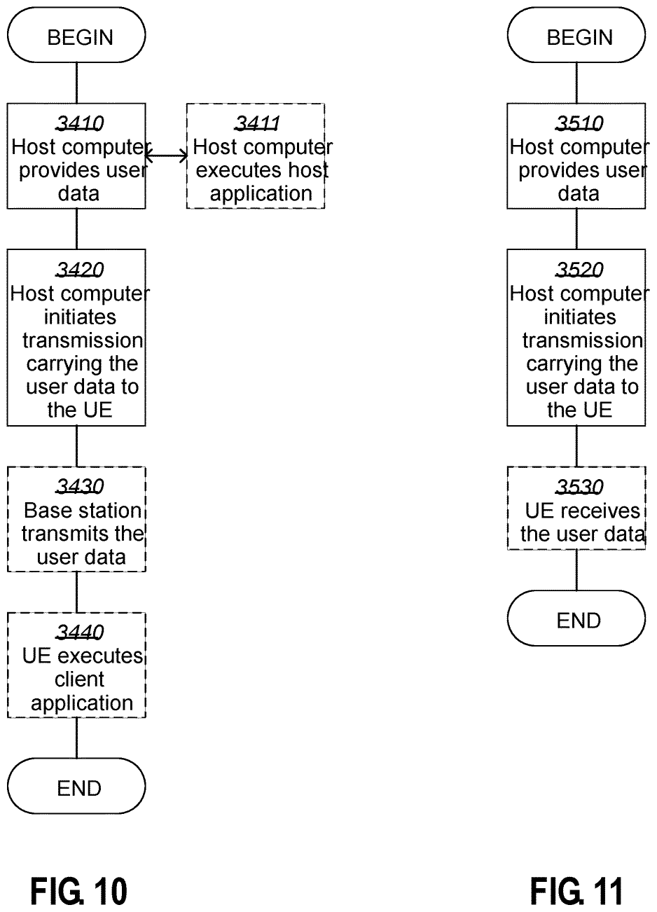

FIG. 10 is a flowchart illustrating a method implemented in a communication system, in accordance with one embodiment. The communication system includes a host computer, a base station such as an AP STA, and a UE such as a Non-AP STA which may be those described with reference to FIG. 8 and FIG. 9. For simplicity of the present disclosure, only drawing references to FIG. 10 will be included in this section. In a first step 3410 of the method, the host computer provides user data. In an optional sub step 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 11 is a flowchart illustrating a method implemented in a communication system, in accordance with one embodiment. The communication system includes a host computer, a base station such as an AP STA, and a UE such as a Non-AP STA which may be those described with reference to FIG. 8 and FIG. 9. For simplicity of the present disclosure, only drawing references to FIG. 11 will be included in this section. In a first step 3510 of the method, the host computer provides user data. In an optional sub step (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

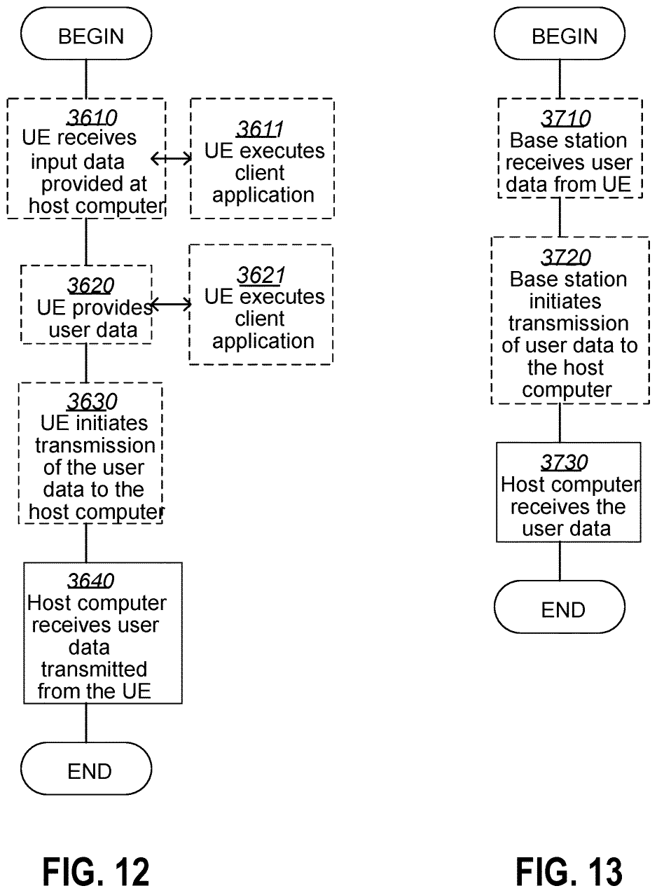

FIG. 12 is a flowchart illustrating a method implemented in a communication system, in accordance with one embodiment. The communication system includes a host computer, a base station such as an AP STA, and a UE such as a Non-AP STA which may be those described with reference to FIG. 8 and FIG. 9. For simplicity of the present disclosure, only drawing references to FIG. 8 will be included in this section. In an optional first step 3610 of the method, the UE receives input data provided by the host computer. Additionally or alternatively, in an optional second step 3620, the UE provides user data. In an optional sub step 3621 of the second step 3620, the UE provides the user data by executing a client application. In a further optional sub step 3611 of the first step 3610, the UE executes a client application which provides the user data in reaction to the received input data provided by the host computer. In providing the user data, the executed client application may further consider user input received from the user.

Regardless of the specific manner in which the user data was provided, the UE initiates, in an optional third sub step 3630, transmission of the user data to the host computer. In a fourth step 3640 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station such as an AP STA, and a UE such as a Non-AP STA which may be those described with reference to FIG. 8 and FIG. 9. For simplicity of the present disclosure, only drawing references to FIG. 9 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

When using the word “comprise” or “comprising” it shall be interpreted as non-limiting, i.e., meaning “consist at least of”.

The embodiments herein are not limited to the above described preferred embodiments. Various alternatives, modifications and equivalents may be used.

1.-20. (canceled)

21. A method performed by a server configured for operation in a communications network, the method comprising:
obtaining a request to extend a memory, associated with a user device in the communications network, according to a location area and a time frame;
receiving additional data requested by the server, wherein the additional data is related to the location area and the time frame, and wherein the additional data is received from one or more devices having one or more of the following characteristics:
related to the user device, and in proximity of the location area;
determining a context based on time, location and type of the additional data;
based on the determined context, identifying whether there are gaps of data needing to be filled in relation to the location area and the time frame; and
performing the following when gaps of data needing to be filled are identified:
filling the identified gaps with simulated data based on the determined context and the received additional data; and
deciding that the context, the simulated data, and the additional data will be a second basis for creating a digital representation of the extended memory according to the request.

22. The method of claim 21, further comprising, when no gaps of data needing to be filled are identified, deciding that the context and the additional data will be a first basis for creating the digital representation of the extended memory according to the request.

23. The method according to claim 22, further comprising receiving, from the user device, data that was captured by the user device within said location area and time frame, wherein:
determining the context is further based on time, location, and type of the captured data;
filling the identified gaps with simulated data is further based on the captured data; and
the captured data further is comprised in the first basis and the second basis.

24. The method of claim 23, wherein each of the captured data and the additional data is related to one or more of the following: image data, video data, audio data, sensor data, text data, object data, and metadata.

25. The method of claim 22, wherein the request to expand the memory further comprises a memory Identifier (Id) associated with the memory to be expanded, and the method further comprises:
based on the first basis or the second basis, creating the digital representation of the extended memory according to the request; and
sending, to the user device, the memory Id associated to the extended memory and one or more of the following:
the created digital representation of the extended memory, and an address for obtaining the digital representation of the extended memory.

26. The method of claim 22, wherein:
the request to expand the memory further comprises a memory Identifier (Id) associated with the memory to be expanded;
the method further comprises sending, to the user device, the memory Id and either the first basis or the second basis; and
the first basis or the second basis, sent to the user device, facilitates creation by the user device of the digital representation of the extended memory according to the request.

27. The method of claim 21, wherein the additional data requested by the server further comprises one or more of the following: first additional data from the user device, second additional data from a media server, and data selected from outside of the determined context.

28. The method of claim 21, wherein obtaining the request is responsive to detecting one of the following key events related to the user device: a moment associated with a specific emotion, a sports highlight, a blooper, an achievement, a celebration, a media content of other users, and a calendar event.

29. The method of claim 22, wherein creating the digital representation of the extended memory according to the request comprises creating a three-dimensional world of the extended memory based on one of the following: the first basis, or the second basis.

30. The method of claim 21, wherein the server is included in one of the following: a cloud computing environment, at least one network node, at least one server node, the user device, an application in the user device, or any of the devices from which the additional data is received.

31. A server configured to for operation in a communications network, the server comprising:
a processor; and
a memory operably coupled to the processor and having stored therein instructions that, when executed by the processor, cause the server to:
obtain a request to extend a memory, associated with a user device in the communications network, according to a location area and a time frame;
receive additional data requested by the server, wherein the additional data is related to the location area and the time frame, and wherein the additional data is received from one or more devices having one or more of the following characteristics: related to the user device, and in proximity of the location area;
determine a context based on time, location and type of the additional data;
based on the determined context, identify whether there are gaps of data needing to be filled in relation to the location area and the time frame; and
perform the following when gaps of data needing to be filled are identified:
fill the identified gaps with simulated data based on the determined context and the received additional data; and
decide that the context, the simulated data, and the additional data will be a second basis for creating a digital representation of the extended memory according to the request.

32. The server of claim 31, wherein execution of the instructions by the processor further causes the server to, when no gaps of data needing to be filled are identified, decide that the context and the additional data will be a first basis for creating the digital representation of the extended memory according to the request.

33. The server of claim 32, wherein:
execution of the instructions by the processor further causes the server to receive, from the user device, data that was captured by the user device within said location area and time frame;
the captured data further is comprised in the first basis and the second basis; and
execution of the instructions by the processor causes the server to:
determine the context further based on time, location, and type of the captured data; and
fill the identified gaps with simulated data further based on the captured data.

34. The server of claim 33, wherein each of the captured data and the additional data is related to one or more of the following: image data, video data, audio data, sensor data, text data, object data, and metadata.

35. The server of claim 32, wherein the request to expand the memory further comprises a memory Identifier (Id) associated with the memory to be expanded, and execution of the instructions by the processor further causes the server to:
based on the first basis or the second basis, create the digital representation of the extended memory according to the request; and
send, to the user device, the memory Id associated with the extended memory and one or more of the following:
the created digital representation of the extended memory, and an address for obtaining the digital representation of the extended memory.

36. The server of claim 32, wherein:
the request to expand the memory further comprises a memory Identifier (Id) associated with the memory to be expanded;
execution of the instructions by the processor further causes the server to send, to the user device, the memory Id and either the first basis or the second basis; and
the first basis or the second basis, sent to the user device, facilitates creation by the user device of the digital representation of the extended memory according to the request.

37. The server of claim 31, wherein the additional data requested by the server further comprises one or more of the following: first additional data from the user device, second additional data from a media server, and data selected from outside of the determined context.

38. The server of claim 31, wherein execution of the instructions by the processor causes the server to obtain the request responsive to detecting one of the following key events related to the user device: a moment associated with a specific emotion, a sports highlight, a blooper, an achievement, a celebration, a media content of other users, and a calendar event.

39. The server of claim 32, wherein execution of the instructions by the processor causes the server to create the digital representation of the extended memory according to the request based on creating a three-dimensional world of the extended memory based on one of the following: the first basis, or the second basis.

40. The server of claim 31, wherein the server is included in one of the following: a cloud computing environment, at least one network node, at least one server node, the user device, an application in the user device, or any of the devices from which the additional data is received.
